(19) United States
(12) Patent Application Publication
(10) Pub. No.: US 2011/0238406 A1
(43) Pub. Date: Sep. 29, 2011

(54) MESSAGING SYSTEM WITH TRANSLATION AND METHOD OF OPERATION THEREOF

(75) Inventors: Hong Chen, San Jose, CA (US); Manohar Ellanti, Fremont, CA (US)

(73) Assignee: TELENAV, INC., Sunnyvale, CA (US)

(21) Appl. No.: 12/730,189

(22) Filed: Mar. 23, 2010

(51) Int. Cl. G06F 17/28

(52) U.S. Cl. 704/3; 704/5

(57) ABSTRACT

A method of operation of a messaging system includes: receiving a source message; identifying a phrase of the source message; searching a translation hierarchy for the phrase, the translation hierarchy having multiple dictionaries in a priority order; and translating a target message, for displaying on a device, from the source message based on the translation hierarchy.

### TECHNICAL FIELD

The present invention relates generally to a messaging system, and more particularly to a system for a messaging system with translation.

### BACKGROUND ART

Modern portable consumer electronics, especially client devices, such as global position systems, cellular phones, and portable digital assistants, are providing increasing levels of functionality to support modern life including location-based services. Numerous technologies have been developed to utilize this new functionality.

As users adopt mobile devices, new and old usages begin to take advantage of this new device space. There are many solutions to take advantage of this new device opportunity. Messaging system and service providers are continually making improvement in the user's experience in order to be competitive. In mobile applications, demand for better usability using audio processing is increasingly important. Audio processing is one of the most useful and yet challenging tasks for exchanging messages.

Thus, a need still remains for a messaging system with audio processing mechanism for providing increasing levels of functionality. In view of ever-increasing added features desired by consumers in their mobile devices, it is increasingly critical that answers be found to these problems. In view of the ever-increasing commercial competitive pressures, along with growing consumer expectations and the diminishing opportunities for meaningful product differentiation in the marketplace, it is critical that answers be found for these problems. Additionally, the need to reduce costs, improve efficiencies and performance, and meet competitive pressures adds an even greater urgency to the critical necessity for finding answers to these problems.

Solutions to these problems have been long sought but prior developments have not taught or suggested any solutions and, thus, solutions to these problems have long eluded those skilled in the art.

### DISCLOSURE OF THE INVENTION

The present invention provides a method of operation of a messaging system including: receiving a source message; identifying a phrase of the source message; searching a translation hierarchy for the phrase, the translation hierarchy having multiple dictionaries in a priority order; and translating a target message, for displaying on a device, from the source message based on the translation hierarchy.

The present invention provides a messaging system, including: a communication unit for receiving a source message; a storage unit, coupled to the communication unit, for identifying a phrase of the source message, the phrase stored and accessed in the storage unit; a control unit, coupled to the storage unit, for searching a translation hierarchy for the phrase, the translation hierarchy having multiple dictionaries in a priority order; and a user interface, coupled to the control unit, for displaying a target message on a device, the target message translated from the source message based on the translation hierarchy.

Certain embodiments of the invention have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

FIG. 1 is a messaging system with translation mechanism in a first embodiment of the present invention.

FIG. 2 is a display interface of the first device.

FIG. 3 is an exemplary block diagram of the first device.

FIG. 4 is an exemplary block diagram of a messaging system with translation mechanism in a second embodiment of the present invention.

FIG. 5 is a messaging system with translation mechanism in a third embodiment of the present invention.

FIG. 6 is a detailed flow chart of the message processor module.

FIG. 7 is a flow chart of a method of operation of a messaging system in a further embodiment of the present invention.

### BEST MODE FOR CARRYING OUT THE INVENTION

The following embodiments are described in sufficient detail to enable those skilled in the art to make and use the invention. It is to be understood that other embodiments would be evident based on the present disclosure, and that system, process, or mechanical changes may be made without departing from the scope of the present invention.

In the following description, numerous specific details are given to provide a thorough understanding of the invention. However, it will be apparent that the invention may be practiced without these specific details. In order to avoid obscuring the present invention, some well-known circuits, system configurations, and process steps are not disclosed in detail.

The drawings showing embodiments of the system are semi-diagrammatic and not to scale and, particularly, some of the dimensions are for the clarity of presentation and are shown exaggerated in the drawing FIGs. Similarly, although the views in the drawings for ease of description generally show similar orientations, this depiction in the FIGs. is arbitrary for the most part. Generally, the invention can be operated in any orientation. The embodiments have been numbered first embodiment, second embodiment, etc. as a matter of descriptive convenience and are not intended to have any other significance or provide limitations for the present invention.

One skilled in the art would appreciate that the format with which navigation information is expressed is not critical to some embodiments of the invention. For example, in some embodiments, navigation information is presented in the format of (X, Y), where X and Y are two ordinates that define the geographic location, i.e., a position of a user.

In an alternative embodiment, navigation information is presented by longitude and latitude related information. In a further embodiment of the present invention, the navigation information also includes a velocity element comprising a speed component and a heading component.

The term “relevant information” referred to herein comprises the navigation information described as well as information relating to points of interest to the user, such as local business, hours of businesses, types of businesses, advertised specials, traffic information, maps, local events, and nearby community or personal information.

The term “module” referred to herein can include software, hardware, or a combination thereof. For example, the software can be machine code, firmware, embedded code, and application software. Also for example, the hardware can be circuitry, processor, computer, integrated circuit, integrated circuit cores, a pressure sensor, an inertial sensor, a microelectromechanical system (MEMS), passive devices, or a combination thereof.

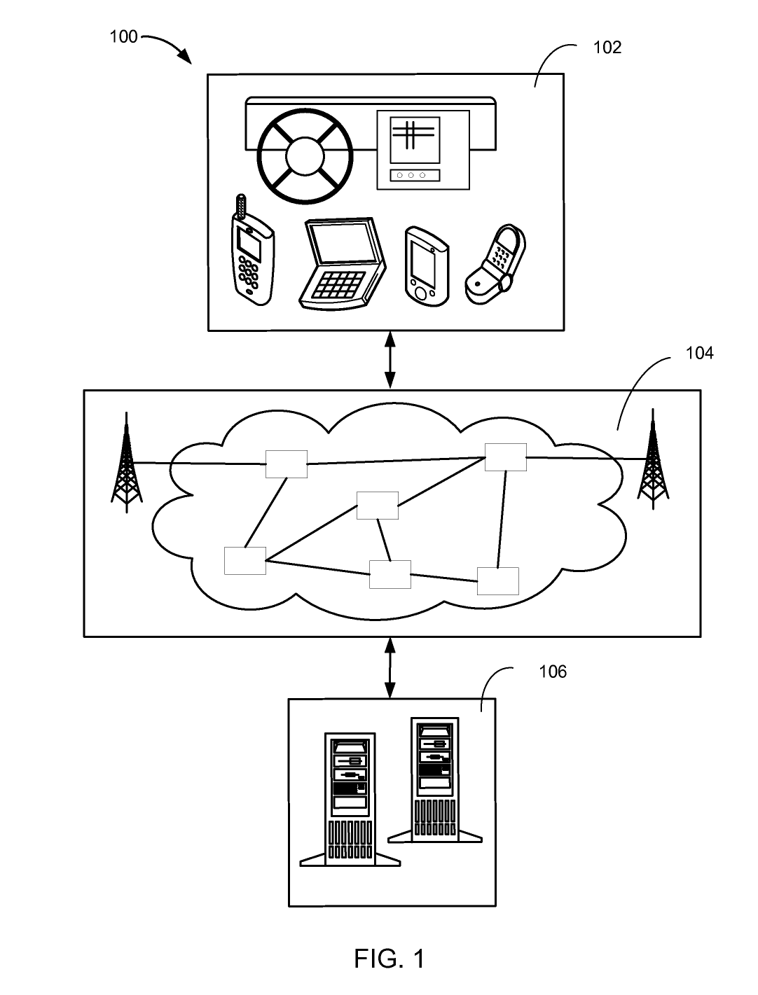

Referring now to FIG. 1, therein is shown a messaging system 100 with translation mechanism in a first embodiment of the present invention. The messaging system 100 includes a first device 102, such as a client or a server, connected to a second device 106, such as a client or server, with a communication path 104, such as a wireless or wired network.

For example, the first device 102 can be of any of a variety of mobile devices, such as a cellular phone, personal digital assistant, a notebook computer, automotive telematic messaging system, or other multi-functional mobile communication or entertainment device. The first device 102 can be a standalone device, or can be incorporated with a vehicle, for example a car, truck, bus, or train. The first device 102 can couple to the communication path 104 to communicate with the second device 106.

For illustrative purposes, the messaging system 100 is described with the first device 102 as a mobile computing device, although it is understood that the first device 102 can be different types of computing devices. For example, the first device 102 can also be a non-mobile computing device, such as a server, a server farm, or a desktop computer.

The second device 106 can be any of a variety of centralized or decentralized computing devices. For example, the second device 106 can be a computer, grid computing resources, a virtualized computer resource, cloud computing resource, routers, switches, peer-to-peer distributed computing devices, or a combination thereof.

The second device 106 can be centralized in a single computer room, distributed across different rooms, distributed across different geographical locations, embedded within a telecommunications network. The second device 106 can have a means for coupling with the communication path 104 to communicate with the first device 102. The second device 106 can also be a client type device as described for the first device 102.

In another example, the first device 102 can be a particularized machine, such as a mainframe, a server, a cluster server, rack mounted server, or a blade server, or as more specific examples, an IBM System z10™ Business Class mainframe or a HP ProLiant ML™ server. Yet another example, the second device 106 can be a particularized machine, such as a portable computing device, a thin client, a notebook, a netbook, a smartphone, personal digital assistant, or a cellular phone, and as specific examples, an Apple iPhone™, Palm Centro™, or Moto Q Global™.

For illustrative purposes, the messaging system 100 is described with the second device 106 as a non-mobile computing device, although it is understood that the second device 106 can be different types of computing devices. For example, the second device 106 can also be a mobile computing device, such as notebook computer, another client device, or a different type of client device. The second device 106 can be a standalone device, or can be incorporated with a vehicle, for example a car, truck, bus, or train.

Also for illustrative purposes, the messaging system 100 is shown with the second device 106 and the first device 102 as end points of the communication path 104, although it is understood that the messaging system 100 can have a different partition between the first device 102, the second device 106, and the communication path 104. For example, the first device 102, the second device 106, or a combination thereof can also function as part of the communication path 104.

The communication path 104 can be a variety of networks. For example, the communication path 104 can include wireless communication, wired communication, optical, ultrasonic, or the combination thereof. Satellite communication, cellular communication, Bluetooth, Infrared Data Association standard (IrDA), wireless fidelity (WiFi), and worldwide interoperability for microwave access (WiMAX) are examples of wireless communication that can be included in the communication path 104. Ethernet, digital subscriber line (DSL), fiber to the home (FTTH), and plain old telephone service (POTS) are examples of wired communication that can be included in the communication path 104.

Further, the communication path 104 can traverse a number of network topologies and distances. For example, the communication path 104 can include direct connection, personal area network (PAN), local area network (LAN), metropolitan area network (MAN), wide area network (WAN) or any combination thereof.

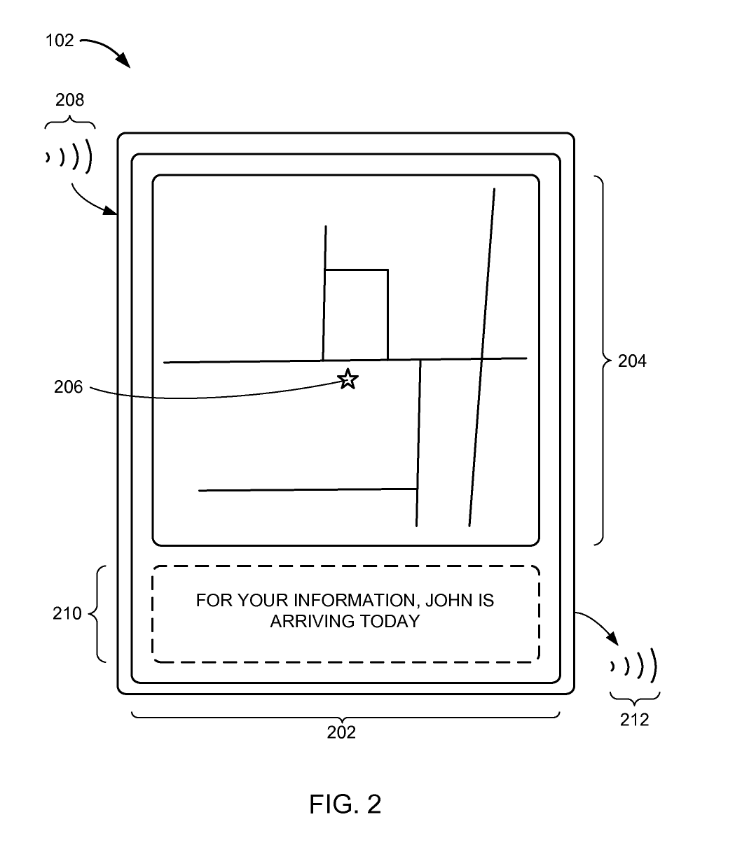

Referring now to FIG. 2, therein is shown a display interface 202 of the first device 102. The display interface 202 is shown having an example of a simulated audio input and a text representation of a simulated audio output. The display interface 202 can include a display, a projector, a video screen, a speaker, or any combination thereof.

The display interface 202 can include a navigation map 204, which can include a visual presentation of an area. The navigation map 204 can include a destination 206 of a point of interest (POI), which can include a type of location that a user finds interesting or useful.

The first device 102 can receive a spoken input 208, which can be an utterance. The spoken input 208 can include information from a user of the first device 102. The first device 102 can process the spoken input 208 to generate a message that is to be sent from the first device 102.

The first device 102 can receive an incoming message 210, which can be information sent from another device to the first device 102. The first device 102 can receive the incoming message 210 via the communication path 104 of FIG. 1. The incoming message 210 can be processed and presented on the first device 102.

For example, the incoming message 210 can be “FYI, John is arriving today”. The incoming message 210 can be processed and displayed as “FOR YOUR INFORMATION, JOHN IS ARRIVING TODAY”.

For illustrative purposes, the incoming message 210 is processed and shown as text, although the incoming message 210 can also be processed and presented with different representations, such as text, audio, images, animation, video, or a combination thereof. The first device 102 can generate an audio output 212, which can include an audible representation of processed information of the incoming message 210.

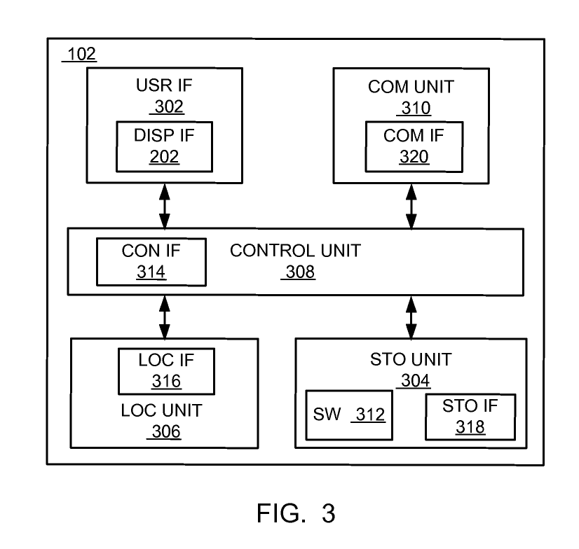

Referring now to FIG. 3, therein is shown an exemplary block diagram of the first device 102. The first device 102 can include a user interface 302, a storage unit 304, a location unit 306, a control unit 308, and a communication unit 310.

The user interface 302 allows a user (not shown) to interface and interact with the first device 102. The user interface 302 can include an input device and an output device. Examples of the input device of the user interface 302 can include a keypad, a touchpad, soft-keys, a keyboard, a microphone, or any combination thereof to provide data and communication inputs. Examples of the output device of the user interface 302 can include the display interface 202. The display interface 202 can include a display, a projector, a video screen, a speaker, or any combination thereof.

The control unit 308 can execute a software 312 to provide the intelligence of the messaging system 100. The control unit 308 can operate the user interface 302 to display information generated by the messaging system 100. The control unit 308 can also execute the software 312 for the other functions of the messaging system 100, including receiving location information from the location unit 306. The control unit 308 can further execute the software 312 for interaction with the communication path 104 of FIG. 1 via the communication unit 310.

The control unit 308 can be implemented in a number of different manners. For example, the control unit 308 can be a processor, an embedded processor, a microprocessor, a hardware control logic, a hardware finite state machine (FSM), a digital signal processor (DSP), or a combination thereof.

The control unit 308 can include a controller interface 314. The controller interface 314 can be used for communication between the control unit 308 and other functional units in the first device 102. The controller interface 314 can also be used for communication that is external to the first device 102.

The controller interface 314 can receive information from the other functional units or from external sources, or can transmit information to the other functional units or to external destinations. The external sources and the external destinations refer to sources and destinations external to the first device 102.

The controller interface 314 can be implemented in different ways and can include different implementations depending on which functional units or external units are being interfaced with the controller interface 314. For example, the controller interface 314 can be implemented with a pressure sensor, an inertial sensor, a microelectromechanical system (MEMS), optical circuitry, waveguides, wireless circuitry, wireline circuitry, or a combination thereof.

The location unit 306 can generate location information, current heading, and current speed of the first device 102, as examples. The location unit 306 can be implemented in many ways. For example, the location unit 306 can function as at least a part of a global positioning system (GPS), an inertial messaging system, a cellular-tower location system, a pressure location system, or any combination thereof.

The location unit 306 can include a location interface 316. The location interface 316 can be used for communication between the location unit 306 and other functional units in the first device 102. The location interface 316 can also be used for communication that is external to the first device 102.

The location interface 316 can receive information from the other functional units or from external sources, or can transmit information to the other functional units or to external destinations. The external sources and the external destinations refer to sources and destinations external to the first device 102.

The location interface 316 can include different implementations depending on which functional units or external units are being interfaced with the location unit 306. The location interface 316 can be implemented with technologies and techniques similar to the implementation of the controller interface 314.

The storage unit 304 can store the software 312. The storage unit 304 can also store the relevant information, such as advertisements, points of interest (POI), navigation routing entries, or any combination thereof.

The storage unit 304 can be a volatile memory, a nonvolatile memory, an internal memory, an external memory, or a combination thereof. For example, the storage unit 304 can be a nonvolatile storage such as non-volatile random access memory (NVRAM), Flash memory, disk storage, or a volatile storage such as static random access memory (SRAM).

The storage unit 304 can include a storage interface 318. The storage interface 318 can be used for communication between the location unit 306 and other functional units in the first device 102. The storage interface 318 can also be used for communication that is external to the first device 102.

The storage interface 318 can receive information from the other functional units or from external sources, or can transmit information to the other functional units or to external destinations. The external sources and the external destinations refer to sources and destinations external to the first device 102.

The storage interface 318 can include different implementations depending on which functional units or external units are being interfaced with the storage unit 304. The storage interface 318 can be implemented with technologies and techniques similar to the implementation of the controller interface 314.

The communication unit 310 can enable external communication to and from the first device 102. For example, the communication unit 310 can permit the first device 102 to communicate with the second device 106 of FIG. 1, an attachment, such as a peripheral device or a computer desktop, and the communication path 104.

The communication unit 310 can also function as a communication hub allowing the first device 102 to function as part of the communication path 104 and not limited to be an end point or terminal unit to the communication path 104. The communication unit 310 can include active and passive components, such as microelectronics or an antenna, for interaction with the communication path 104.

The communication unit 310 can include a communication interface 320. The communication interface 320 can be used for communication between the communication unit 310 and other functional units in the first device 102. The communication interface 320 can receive information from the other functional units or can transmit information to the other functional units.

The communication interface 320 can include different implementations depending on which functional units are being interfaced with the communication unit 310. The communication interface 320 can be implemented with technologies and techniques similar to the implementation of the controller interface 314.

For illustrative purposes, the messaging system 100 is shown with the partition having the user interface 302, the storage unit 304, the location unit 306, the control unit 308, and the communication unit 310 although it is understood that the messaging system 100 can have a different partition. For example, the software 312 can be partitioned differently such that some or all of its function can be in the control unit 308, the location unit 306, and the communication unit 310. Also, the first device 102 can include other functional units not shown in FIG. 3 for clarity.

The functional units in the first device 102 can work individually and independently of the other functional units. The first device 102 can work individually and independently from the second device 106 and the communication path 104.

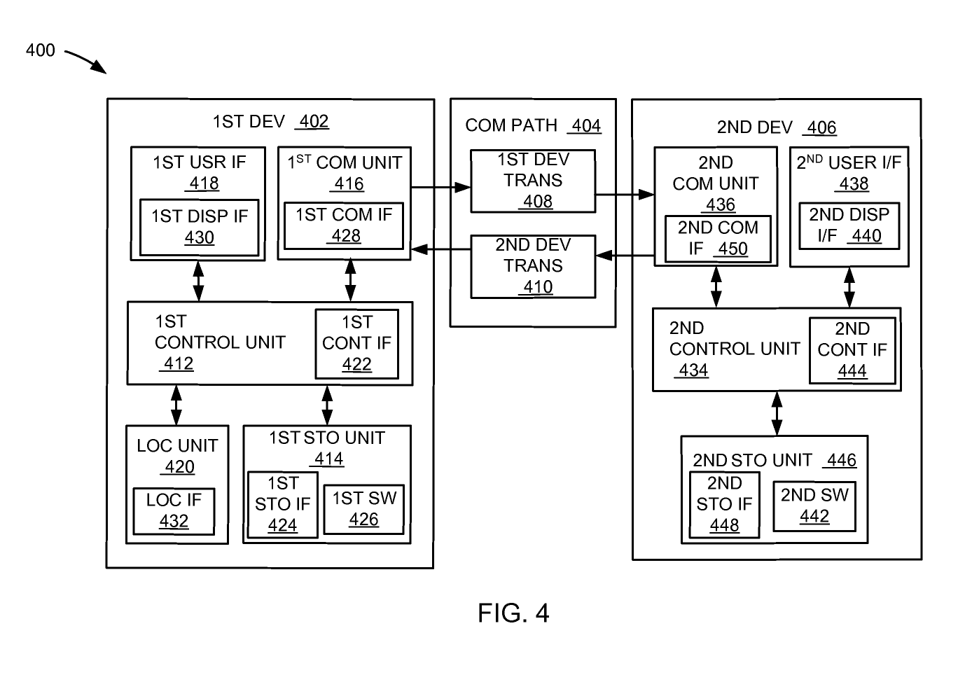

Referring now to FIG. 4, therein is shown an exemplary block diagram of a messaging system 400 with translation mechanism in a second embodiment of the present invention. The messaging system 400 can include a first device 402, a communication path 404, and a second device 406.

The first device 402 can communicate with the second device 406 over the communication path 404. For example, the first device 402, the communication path 404, and the second device 406 can be the first device 102 of FIG. 1, the communication path 104 of FIG. 1, and the second device 106 of FIG. 1, respectively. The screen shot shown on the display interface 202 described in FIG. 2 can represent the screen shot for the messaging system 400.

The first device 402 can send information in a first device transmission 408 over the communication path 404 to the second device 406. The second device 406 can send information in a second device transmission 410 over the communication path 404 to the first device 402.

For illustrative purposes, the messaging system 400 is shown with the first device 402 as a client device, although it is understood that the messaging system 400 can have the first device 402 as a different type of device. For example, the first device 402 can be a server.

Also for illustrative purposes, the messaging system 400 is shown with the second device 406 as a server, although it is understood that the messaging system 400 can have the second device 406 as a different type of device. For example, the second device 406 can be a client device.

For brevity of description in this embodiment of the present invention, the first device 402 will be described as a client device and the second device 406 will be described as a server device. The present invention is not limited to this selection for the type of devices. The selection is an example of the present invention.

The first device 402 can include a first control unit 412, a first storage unit 414, a first communication unit 416, a first user interface 418, and a location unit 420. The first device 402 can be similarly described by the first device 102.

The first control unit 412 can include a first controller interface 422. The first control unit 412 and the first controller interface 422 can be similarly described as the control unit 308 of FIG. 3 and the controller interface 314 of FIG. 3, respectively.

The first storage unit 414 can include a first storage interface 424. The first storage unit 414 and the first storage interface 424 can be similarly described as the storage unit 304 of FIG. 3 and the storage interface 318 of FIG. 3, respectively. A first software 426 can be stored in the first storage unit 414.

The first communication unit 416 can include a first communication interface 428. The first communication unit 416 and the first communication interface 428 can be similarly described as the communication unit 310 of FIG. 3 and the communication interface 320 of FIG. 3, respectively.

The first user interface 418 can include a first display interface 430. The first user interface 418 and the first display interface 430 can be similarly described as the user interface 302 of FIG. 3 and the display interface 202 of FIG. 3, respectively.

The location unit 420 can include a location interface 432. The location unit 420 and the location interface 432 can be similarly described as the location unit 306 of FIG. 3 and the location interface 316 of FIG. 3, respectively.

The performance, architectures, and type of technologies can also differ between the first device 102 and the first device 402. For example, the first device 102 can function as a single device embodiment of the present invention and can have a higher performance than the first device 402. The first device 402 can be similarly optimized for a multiple device embodiment of the present invention.

For example, the first device 102 can have a higher performance with increased processing power in the control unit 308 compared to the first control unit 412. The storage unit 304 can provide higher storage capacity and access time compared to the first storage unit 414.

Also for example, the first device 402 can be optimized to provide increased communication performance in the first communication unit 416 compared to the communication unit 310. The first storage unit 414 can be sized smaller compared to the storage unit 304. The first software 426 can be smaller than the software 312 of FIG. 3.

The second device 406 can be optimized for implementing the present invention in a multiple device embodiment with the first device 402. The second device 406 can provide the additional or higher performance processing power compared to the first device 402. The second device 406 can include a second control unit 434, a second communication unit 436, and a second user interface 438.

The second user interface 438 allows a user (not shown) to interface and interact with the second device 406. The second user interface 438 can include an input device and an output device. Examples of the input device of the second user interface 438 can include a keypad, a touchpad, soft-keys, a keyboard, a microphone, or any combination thereof to provide data and communication inputs. Examples of the output device of the second user interface 438 can include a second display interface 440. The second display interface 440 can include a display, a projector, a video screen, a speaker, or any combination thereof.

The second control unit 434 can execute a second software 442 to provide the intelligence of the second device 106 of the messaging system 400. The second software 442 can operate in conjunction with the first software 426. The second control unit 434 can provide additional performance compared to the first control unit 412 or the control unit 308.

The second control unit 434 can operate the second user interface 438 to display information. The second control unit 434 can also execute the second software 442 for the other functions of the messaging system 400, including operating the second communication unit 436 to communicate with the first device 402 over the communication path 404.

The second control unit 434 can be implemented in a number of different manners. For example, the second control unit 434 can be a processor, an embedded processor, a microprocessor, a hardware control logic, a hardware finite state machine (FSM), a digital signal processor (DSP), or a combination thereof.

The second control unit 434 can include a second controller interface 444. The second controller interface 444 can be used for communication between the second control unit 434 and other functional units in the second device 406. The second controller interface 444 can also be used for communication that is external to the second device 406.

The second controller interface 444 can receive information from the other functional units or from external sources, or can transmit information to the other functional units or to external destinations. The external sources and the external destinations refer to sources and destinations external to the second device 406.

The second controller interface 444 can be implemented in different ways and can include different implementations depending on which functional units or external units are being interfaced with the second controller interface 444. For example, the second controller interface 444 can be implemented with a pressure sensor, an inertial sensor, a microelectromechanical system (MEMS), optical circuitry, waveguides, wireless circuitry, wireline circuitry, or a combination thereof.

A second storage unit 446 can store the second software 442. The second storage unit 446 can also store the relevant information, such as advertisements, points of interest (POI), navigation routing entries, or any combination thereof. The second storage unit 446 can be sized to provide the additional storage capacity to supplement the first storage unit 414.

For illustrative purposes, the second storage unit 446 is shown as a single element, although it is understood that the second storage unit 446 can be a distribution of storage elements. Also for illustrative purposes, the messaging system 400 is shown with the second storage unit 446 as a single hierarchy storage system, although it is understood that the messaging system 400 can have the second storage unit 446 in a different configuration. For example, the second storage unit 446 can be formed with different storage technologies forming a memory hierarchal system including different levels of caching, main memory, rotating media, or off-line storage.

The second storage unit 446 can be a volatile memory, a nonvolatile memory, an internal memory, an external memory, or a combination thereof. For example, the second storage unit 446 can be a nonvolatile storage such as non-volatile random access memory (NVRAM), Flash memory, disk storage, or a volatile storage such as static random access memory (SRAM).

The second storage unit 446 can include a second storage interface 448. The second storage interface 448 can be used for communication between the location unit 306 and other functional units in the second device 406. The second storage interface 448 can also be used for communication that is external to the second device 406.

The second storage interface 448 can receive information from the other functional units or from external sources, or can transmit information to the other functional units or to external destinations. The external sources and the external destinations refer to sources and destinations external to the second device 406.

The second storage interface 448 can include different implementations depending on which functional units or external units are being interfaced with the second storage unit 446. The second storage interface 448 can be implemented with technologies and techniques similar to the implementation of the second controller interface 444.

The second communication unit 436 can enable external communication to and from the second device 406. For example, the second communication unit 436 can permit the second device 406 to communicate with the first device 402 over the communication path 404.

The second communication unit 436 can also function as a communication hub allowing the second device 406 to function as part of the communication path 404 and not limited to be an end point or terminal unit to the communication path 404. The second communication unit 436 can include active and passive components, such as microelectronics or an antenna, for interaction with the communication path 404.

The second communication unit 436 can include a second communication interface 450. The second communication interface 450 can be used for communication between the second communication unit 436 and other functional units in the second device 406. The second communication interface 450 can receive information from the other functional units or can transmit information to the other functional units.

The second communication interface 450 can include different implementations depending on which functional units are being interfaced with the second communication unit 436. The second communication interface 450 can be implemented with technologies and techniques similar to the implementation of the second controller interface 444.

The first communication unit 416 can couple with the communication path 404 to send information to the second device 406 in the first device transmission 408. The second device 406 can receive information in the second communication unit 436 from the first device transmission 408 of the communication path 404.

The second communication unit 436 can couple with the communication path 404 to send information to the first device 402 in the second device transmission 410. The first device 402 can receive information in the first communication unit 416 from the second device transmission 410 of the communication path 404. The messaging system 400 can be executed by the first control unit 412, the second control unit 434, or a combination thereof.

For illustrative purposes, the second device 106 is shown with the partition having the second user interface 438, the second storage unit 446, the second control unit 434, and the second communication unit 436, although it is understood that the second device 106 can have a different partition. For example, the second software 442 can be partitioned differently such that some or all of its function can be in the second control unit 434 and the second communication unit 436. Also, the second device 406 can include other functional units not shown in FIG. 4 for clarity.

The functional units in the first device 402 can work individually and independently of the other functional units. The first device 402 can work individually and independently from the second device 406 and the communication path 404.

The functional units in the second device 406 can work individually and independently of the other functional units. The second device 406 can work individually and independently from the first device 402 and the communication path 404.

For illustrative purposes, the messaging system 400 is described by operation of the first device 402 and the second device 406. It is understood that the first device 402 and the second device 406 can operate any of the modules and functions of the messaging system 400. For example, the first device 402 is described to operate the location unit 420, although it is understood that the second device 406 can also operate the location unit 420.

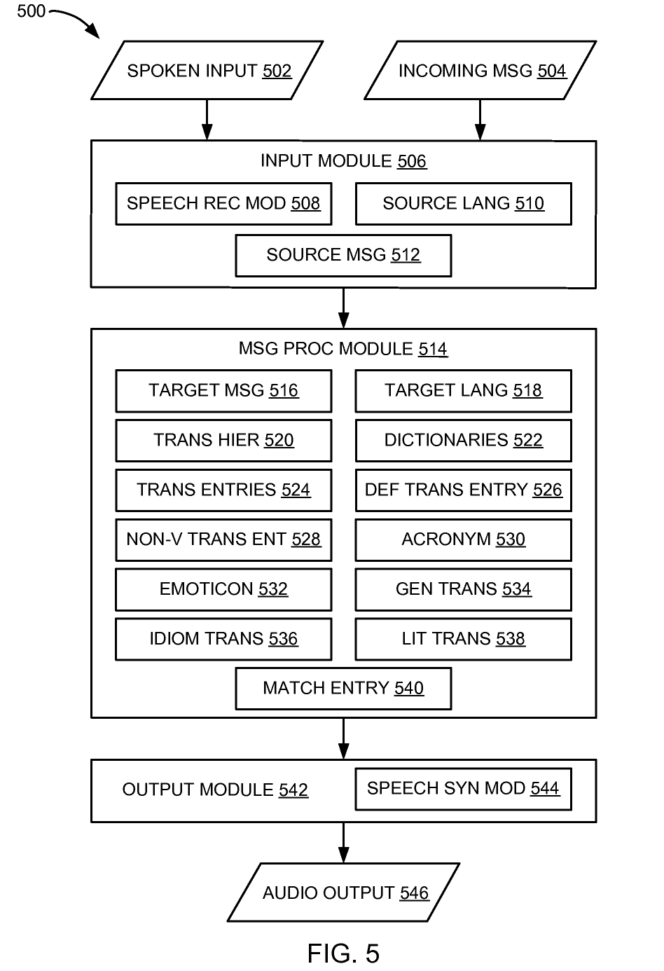

Referring now to FIG. 5, therein is shown a messaging system 500 with translation mechanism in a third embodiment of the present invention. The messaging system 500 can be implemented for a mobile message system. The messaging system 500 can include a spoken input 502. The spoken input 208 of FIG. 2 can represent the spoken input 502. The spoken input 502 can include information that can be used to compose a message that is to be sent from the first device 402 of FIG. 4.

The messaging system 500 can include an incoming message 504. The incoming message 210 of FIG. 2 can represent the incoming message 504. The incoming message 504 can be processed and presented on the first device 402.

The messaging system 500 can include an input module 506 to receive the spoken input 502 or the incoming message 504. The input module 506 can receive the spoken input 502 or the incoming message 504 when composing a message that is to be sent from the first device 402 in an outbound direction or receiving a message that is sent from another device to the first device 402 in an inbound direction, respectively.

The input module 506 can include a speech recognition module 508 to convert the spoken input 502 to text or another format that can be further processed. For example, raw audio data of the spoken input 502 can be un-compressed and converted to a unified format. Also for example, the speech recognition module 508 can include statistically-based speech recognition algorithms including acoustic modeling and language modeling, automatic speech recognition, computer speech recognition, or voice recognition.

The input module 506 can receive the spoken input 502 or the incoming message 504 in a source language 510. The source language 510 can include a method or a system of communication. The source language 510 can include a language or a combination of languages.

The source language 510 can include a natural language or an ordinary language that is used by a community, a region, or a country. For example, the source language 510 can include English, Chinese, Spanish, Hindi, German, Italian, or French.

The source language 510 can include a machine language, a computer-programming language, or a language that is used in the study of formal logic or mathematical logic. The source language 510 can include a code that uses character encoding.

The source language 510 can include a non-verbal language that can be represented by icons, symbols, pictures, images, or pictographs. The source language 510 can include a sign language that includes visual patterns or symbols to convey meanings.

The source language 510 can be selected or preset. The input module 506 can select the spoken input 502 or the incoming message 504 to generate a source message 512 that is composed in the source language 510.

The input module 506 can be implemented with the messaging system 400 of FIG. 4. For example, the input module 506 can be implemented with the first control unit 412 of FIG. 4, the first communication unit 416 of FIG. 4, the first user interface 418 of FIG. 4, the first storage unit 414 of FIG. 4 having the first storage interface 424 of FIG. 4 and the first software 426 of FIG. 4, the communication path 404 of FIG. 4, the second control unit 434 of FIG. 4, the second communication unit 436 of FIG. 4, the second user interface 438 of FIG. 4, the second storage unit 446 of FIG. 4 having the second storage interface 448 of FIG. 4 and the second software 442 of FIG. 4, or a combination thereof.

The messaging system 500 can include a message processor module 514 to receive and further process the source message 512. The message processor module 514 can translate the source message 512 to a target message 516 before sending or presenting the target message 516 in the outbound direction or the inbound direction, respectively. The target message 516 can include text, audio, images, animation, video, or a combination thereof.

The message processor module 514 can translate the source message 512 to the target message 516 based on the source language 510 and a target language 518. The target language 518 can be the same as or different than the source language 510.

The target language 518 can include any of the languages or a combination thereof as previously described for the source language 510. The target language 518 can be selected or preset.

The message processor module 514 can translate the source message 512 to compose the target message 516 by searching or traversing a translation hierarchy 520, which can include multiple dictionaries 522 that are searched in a priority order. The dictionaries 522 can preferably include definitions of words or a translation of a word or a group of words from the source language 510 to the target language 518.

The dictionaries 522 can be defined based on different scopes. For example, the scope can be determined by two or more of the dictionaries 522 including a default dictionary that is widely used in the messaging system 500, a user-defined dictionary, a dictionary having definitions used by a sender of the incoming message 504 in the inbound direction, or a dictionary having definitions used by a recipient of the target message 516 in the outbound direction.

The dictionaries 522 can include one or more translation entries 524. The translation entries 524 can include one or more definitions of the word or the group of words in the source message 512.

The translation entries 524 can include a default translation entry 526 as a preferred definition for the word or the group of words that have multiple definitions in the translation entries 524. The translation entries 524 can include a non-verbal translation entry 528, which can include an unspoken representation of the word or the group of words. The non-verbal translation entry 528 can include audio, images, animation, or video, as examples.

The translation entries 524 can include an acronym 530, which can include an abbreviation or a short form of the word or the group of words. In the outbound direction, the message processor module 514 can contract, compress, or shorten a portion of the source message 512 by replacing the word or the group of words (e.g. a text string) with the acronym 530. In the inbound direction, the message processor module 514 can expand, elaborate, or lengthen a portion of the source message 512 by replacing the acronym 530 with a definition.

The dictionaries 522 can include the translation entries 524 having the acronym 530 as in the following example.

| Acronym | Definition |
|---|---|
| lol | laughing out loud \| laugh out loud |
| fyi | for your information |
| omg | oh, my Gosh! |
| im | instant messaging |
| ttyl | talk to you later |
| bbl | be back later |
| brb | be right back |
| imho | in my humble opinion |
| jk | just kidding |
| np | no problem |
| otp | on the phone |
| rofl | rolling on floor laughing |
| yw | you are welcome |
| lylas | lover you like a sister |

For example, the acronym 530 “fyi” has a definition of “for your information”. In the outbound direction, the message processor module 514 can replace “for your information” with “fyi”. In the inbound direction, the message processor module 514 can replace “fyi” with “for your information”.

The acronym 530 can be mapped to multiple texts or definitions. The first text or definition can be the default translation entry 526 that can be used by the expansion process in the inbound direction. In other words, the acronym 530 in the source message 512 can be replaced by a definition provided in the default translation entry 526.

For example, the acronym 530 “lol” has multiple definitions of “laughing out loud” and “laugh out loud”. As an example, the default translation entry 526 of the acronym 530 “lol” can be the first entry, which is “laughing out loud”. Thus, the message processor module 514 can replace the acronym 530 “lol” with the default translation entry 526 “laughing out loud” in the inbound direction.

For illustrative purposes, the acronym 530 and its definition are shown in lower-case, although the acronym 530 can be included in the dictionaries 522 with a different letter case. For example, the acronym 530 can include upper-case, lower-case, or a combination thereof.

The translation entries 524 can include an emoticon 532, which can include a symbolic or iconic representation of a facial expression or emotion. The dictionaries 522 can include the translation entries 524 having the emoticon 532 as in the following example.

| Emoticon | Definition |
|---|---|
| :-) | emoticon smile |
| :-( | emoticon sad |

For example, if the message processor module 514 recognizes that the source message 512 includes “emoticon smile” in the outbound direction, the message processor module 514 can replace “emoticon smile” with the emoticon 532 “:-)” when composing the target message 516. Also for example, if the message processor module 514 detects that the source message 512 includes the emoticon 532 “:-)” in the inbound direction, the message processor module 514 can literally replace the emoticon 532 “:-)” with “emoticon smile”. Alternatively, the emoticon 532 “:-)” can be replaced with the non-verbal translation entry 528 of the emoticon 532 “:-)”, which can include special, un-spoken audio like a sound of giggling to express the emotion audibly.

The message processor module 514 can translate the source message 512 with a generational translation 534. The translation entries 524 can include the generational translation 534 with a definition of a word or a group of words based on a person with a particular birth date or a person in an age group at the time of the invention. For example, the translation entries 524 can include an entry with a word “sick” and a definition of “ill” for a person in his/her 40s such as those born in 1960-1969. Also for example, the translation entries 524 can include an entry with a word “sick” and a definition of “good” for a person in his/her 20s such as those born in 1980-1989.

The generational translation 534 can include a generational slang that is used among people of a particular age group. For example, “phat” can be a slang version of “fat”. Also for example, “phat” can mean “excellent”, “cool”, or “greatest”. As an example, the message processor module 514 can replace “phat” in the source message 512 with “fat” when generating the target message 516 in the outbound direction or the inbound direction.

The message processor module 514 can translate the source message 512 with an idiom translation 536. The translation entries 524 can include the generational translation 534 with a definition of a word or a group of words based on a language that is used by a specific group of people. The idiom translation 536 can include a conversion of words that are based on the language that is used by people from a community, a district, a region, or a country.

The idiom translation 536 can be applied to an expression whose meanings cannot be inferred from the meanings of the words that make up the expression. For example, the message processor module 514 can replace “put the eye on the Dragon” in the source message 512 with a definition from Chinese to mean “something so simple as drawing one dot for the eye can be so important to bring the Dragon to life and fly away”, when generating the target message 516.

The message processor module 514 can translate the source message 512 with a literary translation 538. The translation entries 524 can include the literary translation 538 of a literature, a novel, a short story, a play, or a poem, as examples. For example, the message processor module 514 can replace “air drawn dagger” in the source message 512 with a definition from Shakespeare Macbeth to mean “want to kill someone”, when generating the target message 516.

The message processor module 514 can traverse the translation hierarchy 520 to search or select a match entry 540 in one of the dictionaries 522. The match entry 540 can be found when the word or the group of words in the source message 512 is included in the dictionaries 522.

The message processor module 514 can be implemented with the messaging system 400 of FIG. 4. For example, the message processor module 514 can be implemented with the first control unit 412 of FIG. 4, the first communication unit 416 of FIG. 4, the first user interface 418 of FIG. 4, the first storage unit 414 of FIG. 4 having the first storage interface 424 of FIG. 4 and the first software 426 of FIG. 4, the communication path 404 of FIG. 4, the second control unit 434 of FIG. 4, the second communication unit 436 of FIG. 4, the second user interface 438 of FIG. 4, the second storage unit 446 of FIG. 4 having the second storage interface 448 of FIG. 4 and the second software 442 of FIG. 4, or a combination thereof.

The messaging system 500 can include an output module 542 to send or present/display the target message 516 in the outbound direction or the inbound direction, respectively. The output module 542 can include a speech synthesis module 544, which can include functions for generating human speech. The speech synthesis module 544 can include a text-to-speech system for converting written words or characters into spoken words or characters.

The speech synthesis module 544 can generate an audio output 546, which can include an audible representation of the target message 516. The audio output 212 of FIG. 2 can represent the audio output 546.

In the outbound direction, the output module 542 can include the speech synthesis module 544 to generate the audio output 546 of the target message 516 that is generated from the source message 512 based on the spoken input 502. The audio output 546 can be presented or played back on the first device 402 so that the target message 516 can be confirmed as correct before the target message 516 can be sent from the first device 402.

In the inbound direction, the speech synthesis module 544 can generate the audio output 546 of the target message 516 that is generated from the source message 512 based on the incoming message 504. The audio output 546 can be presented or played on the first device 402.

The output module 542 can be implemented with the messaging system 400 of FIG. 4. For example, the output module 542 can be implemented with the first control unit 412 of FIG. 4, the first communication unit 416 of FIG. 4, the first user interface 418 of FIG. 4, the first storage unit 414 of FIG. 4 having the first storage interface 424 of FIG. 4 and the first software 426 of FIG. 4, the communication path 404 of FIG. 4, the second control unit 434 of FIG. 4, the second communication unit 436 of FIG. 4, the second user interface 438 of FIG. 4, the second storage unit 446 of FIG. 4 having the second storage interface 448 of FIG. 4 and the second software 442 of FIG. 4, or a combination thereof.

It has been discovered that the translation hierarchy 520 greatly improves quality of the target message 516. The translation hierarchy 520 having multiple of the dictionaries 522 provides a clear and effective presentation of the target message 516.

It has also been discovered that the translation entries 524 having the generational translation 534, the idiom translation 536, and the literary translation 538 further improves quality of the target message 516.

It has been unexpectedly found that the translation entries 524 includes an efficient messaging method, without which it would require a considerable amount of time to manually look up meanings of unfamiliar words or phrases.

The physical transformation of data of the spoken input 502 or the incoming message 504 to the target message 516 results in movement in the physical world, such as people using the first device 402, the second device 406 of FIG. 4, the messaging system 500, or vehicles, based on the operation of the messaging system 500. As the movement in the physical world occurs, the movement itself creates additional information that is converted back to the data for further processing with the spoken input 502 or the incoming message 504 for the continued operation of the messaging system 500 and to continue the movement in the physical world.

Thus, it has been discovered that the messaging system 500 of the present invention furnishes important and heretofore unknown and unavailable solutions, capabilities, and functional aspects for improving quality.

The messaging system 500 describes the module functions or order as an example. The modules can be partitioned differently. For example, the message processor module 514 can be implemented in multiple modules. Each of the modules can operate individually and independently of the other modules.

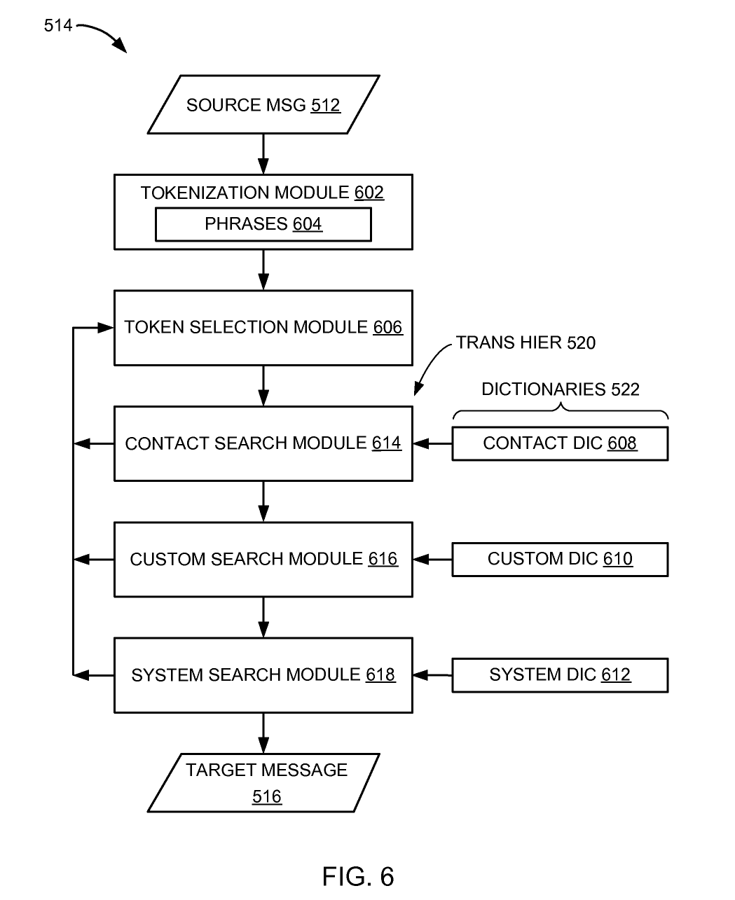

Referring now to FIG. 6, therein is shown a detailed flow chart of the message processor module 514. The message processor module 514 can include a tokenization module 602, which can include a process of splitting or dividing a message into phrases 604, such as components, words, or groups of text. The phrases 604 can be stored and accessed in the first storage unit 414 of FIG. 4, the second storage unit 446 of FIG. 4, or a combination thereof.

The message processor module 514 can translate the phrases 604 to the target language 518 of FIG. 5 and the translation methods as previous described. For example, the message processor module 514 can select the generational translation 534 of FIG. 5, the idiom translation 536 of FIG. 5, or the literary translation 538 of FIG. 5 for the phrases 604 using one of the dictionaries 522 to generate the target message 516. Also for example, the non-verbal translation entry 528 of FIG. 5 can be searched in the dictionaries 522 and selected for one of the phrases 604.

The tokenization module 602 can identify the phrases 604 of the source message 512 with a set of one or more characters as delimiters that determine where the splits should occur. It is understood that the splitting process can produce or return a single phrase or multiple of the phrases 604.

The message processor module 514 can include a token selection module 606 to select one of the phrases 604 for further processing. The phrases 604 can be further processed or searched by traversing the translation hierarchy 520 having the dictionaries 522. The dictionaries 522 can be used by the message processor module 514 to translate or convert the phrases 604 in the source message 512 when generating or composing the target message 516.

The dictionaries 522 can be defined in different scopes. The messaging system 500 of FIG. 5 can apply the dictionaries 522 to generate the target message 516 based on the translation hierarchy 520 of FIG. 5. For example, the dictionaries 522 can include a contact dictionary 608, a custom dictionary 610, and a system dictionary 612.

The contact dictionary 608 can be defined as a dictionary that is defined by a sending or receiving device. The contact dictionary 608 can be associated with a specific device or user interacting with the messaging system 500. The custom dictionary 610 can be defined by the user. The system dictionary 612 can be a default dictionary that is widely used in the messaging system 500.

The dictionaries 522 can be configured, preset, or stored in the first storage unit 414 of FIG. 4, the second storage unit 446 of FIG. 4, or a combination thereof. The dictionaries 522 can be searched with the translation hierarchy 520 having an order of the contact dictionary 608, the custom dictionary 610, and the system dictionary 612, wherein an upper portion and a lower portion of a search chain includes the contact dictionary 608 and the system dictionary 612, respectively.

The message processor module 514 can include a contact search module 614, a custom search module 616, and a system search module 618 to search for the phrases 604 in the contact dictionary 608, the custom dictionary 610, and the system dictionary 612, respectively. The contact search module 614, the custom search module 616, and the system search module 618 can search the dictionaries 522 to find or select definitions of the phrases 604.

If one of the dictionaries 522 is found in the upper portion of the search chain includes the phrases 604, the search process in the message processor module 514 stops. Otherwise, the search process continues in the translation hierarchy 520 to find an appropriate dictionary to process the translation entries 524 of FIG. 5.

For example, the contact search module 614 searches for the match entry 540 of FIG. 5 in the contact dictionary 608 to translate a first phrase. If the translation entries 524 in the contact dictionary 608 do not include the match entry 540, the search process continues with the custom search module 616. If the translation entries 524 in the contact dictionary 608 include the match entry 540, a definition of the first phrase that is provided by the contact dictionary 608 is used by the message processor module 514 to compose the target message 516.

After the first phrase is searched, the token selection module 606 selects a second phrase, and the search process repeats starting with the contact search module 614. The search process completes when all of the phrases 604 are completely searched.

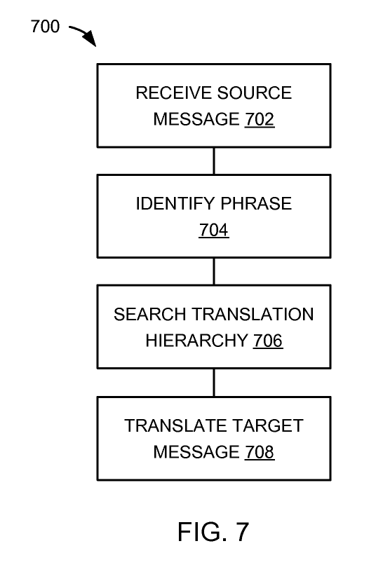

Referring now to FIG. 7, therein is shown a flow chart of a method 700 of operation of a messaging system in a further embodiment of the present invention. The method 700 includes: receiving a source message in a block 702; identifying a phrase of the source message in a block 704; searching a translation hierarchy for the phrase, the translation hierarchy having multiple dictionaries in a priority order in a block 706; and translating a target message, for displaying on a device, from the source message based on the translation hierarchy in a block 708.

The resulting method, process, apparatus, device, product, and/or system is straightforward, cost-effective, uncomplicated, highly versatile, accurate, sensitive, and effective, and can be implemented by adapting known components for ready, efficient, and economical manufacturing, application, and utilization.

Another important aspect of the present invention is that it valuably supports and services the historical trend of reducing costs, simplifying systems, and increasing performance.

These and other valuable aspects of the present invention consequently further the state of the technology to at least the next level.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters hithertofore set forth herein or shown in the accompanying drawings are to be interpreted in an illustrative and non-limiting sense.

What is claimed is:

1. A method of operation of a messaging system comprising:
receiving a source message;
identifying a phrase of the source message;
searching a translation hierarchy for the phrase, the translation hierarchy having multiple dictionaries in a priority order; and
translating a target message, for displaying on a device, from the source message based on the translation hierarchy.

2. The method as claimed in claim 1 further comprising using the phrase for selecting a generational translation thereof, the generational translation based on an age group.

3. The method as claimed in claim 1 further comprising using the phrase for selecting an idiom translation thereof.

4. The method as claimed in claim 1 further comprising using the phrase for selecting a literary translation thereof.

5. The method as claimed in claim 1 wherein receiving the source message includes:
receiving the source message in a source language; and
further comprising:
translating the phrase to a target language different than the source language.

6. A method of operation of a messaging system comprising:
receiving a source message;
identifying a phrase of the source message;
searching a translation hierarchy for the phrase, the translation hierarchy having two or more dictionaries in a priority order;
translating a target message, for displaying on a device, from the source message based on the translation hierarchy; and
generating an audio output of the target message.

7. The method as claimed in claim 6 further comprising selecting a match entry of the phrase in the translation hierarchy.

8. The method as claimed in claim 6 further comprising translating the phrase with translation entries in the dictionaries, the translation entries having a default translation entry.

9. The method as claimed in claim 6 further comprising selecting a non-verbal translation entry for the phrase.

10. The method as claimed in claim 6 further comprising confirming the target message with the audio output, the target message sent from the device.

11. A messaging system comprising:
a communication unit for receiving a source message;
a storage unit, coupled to the communication unit, for identifying a phrase of the source message, the phrase stored and accessed in the storage unit;
a control unit, coupled to the storage unit, for searching a translation hierarchy for the phrase, the translation hierarchy having multiple dictionaries in a priority order; and
a user interface, coupled to the control unit, for displaying a target message on a device, the target message translated from the source message based on the translation hierarchy.

12. The system as claimed in claim 11 wherein the control unit is for using the phrase for selecting a generational translation thereof, the generational translation based on an age group.

13. The system as claimed in claim 11 wherein the control unit is for using the phrase for selecting an idiom translation thereof.

14. The system as claimed in claim 11 wherein the control unit is for using the phrase for selecting a literary translation thereof.

15. The system as claimed in claim 11 wherein:
the communication unit is for receiving the source message in a source language; and
the control unit is for translating the phrase to a target language different than the source language.

16. The system as claimed in claim 11 wherein:
the control unit is for searching the translation hierarchy for the phrase, the translation hierarchy having two or more of the dictionaries in the priority order; and
the user interface is for generating an audio output of the target message.

17. The system as claimed in claim 16 wherein the control unit is for selecting a match entry of the phrase in the translation hierarchy.

18. The system as claimed in claim 16 wherein the control unit is for translating the phrase with translation entries in the dictionaries, the translation entries having a default translation entry.

19. The system as claimed in claim 16 wherein the control unit is for selecting a non-verbal translation entry for the phrase.

20. The system as claimed in claim 16 wherein the user interface is for confirming the target message with the audio output, the target message sent from the device.
